(19) United States
(12) Patent Application Publication
(10) Pub. No.: US 2017/0339335 A1
(43) Pub. Date: Nov. 23, 2017

(54) FINGER CAMERA OFFSET MEASUREMENT

(71) Applicant: OptoFidelity Oy, Tampere (FI)

(72) Inventors: Antti Kuokkanen, Tampere (FI); Jari Nuutinen, Tampere (FI); Hans Kuosmanen, Tampere (FI)

(21) Appl. No.: 15/160,114

(22) Filed: May 20, 2016

(51) Int. Cl. H04N 5/232; H04N 5/247; H04N 5/225

(52) U.S. Cl. CPC H04N 5/23216; H04N 5/2256; H04N 5/247

(57) ABSTRACT

A method and apparatus for illuminating a reference object located at a reference point by a first illumination unit includes capturing a first image of the reference object towards the illumination unit by a first calibrating camera; using the first image to determine a location of the reference point; capturing a second image of the reference object by the camera of the testing probe; using the second image to adjust the location of the testing probe so that the camera of the testing point is located at the reference point; adjusting the location of testing probe based on an offset; capturing a third image of the touch pin by the first calibrating camera; using the third image to determine a location of the touch pin; determining a difference between the location of the touch pin and the reference point; and correcting the offset based on the difference.

### FIELD

The aspects of the disclosed embodiments relate to a method for calibrating a testing apparatus. The aspects of the disclosed embodiments also relate to an apparatus for calibrating the testing apparatus. The aspects of the disclosed embodiments further relate to a computer program product for calibrating the testing apparatus.

### BACKGROUND

Apparatuses and methods have been developed for testing devices having a display without opening the device or connecting any measuring equipment to the device. Such apparatuses may comprise a testing probe having a touch pin, which may be used to imitate a finger of a user of a device under test (DUT). Hence, such a touch pin may also be called as a testing finger. The testing probe may be moved by a robotic arm to different locations and the touch pin may be moved to touch a surface or a key of the device under test, wherein different kinds of touches to the device under test may be simulated. For example, the touch pin may simulate presses of keys of the device, touches on a touch panel of the device, different kinds of gestures on the touch panel etc.

Testing probes may also have a camera which may be used to detect locations where the touching finger should touch the device under test and to capture images of the device to analyze responses of the device to the touches. For example, when a display under the touch panel displays keys of a keyboard and the touching finger should touch a certain key displayed on the screen, the camera may capture an image of the display and a controller of the testing device may analyze the image to find out the location of the key on the display. Then, the controller may provide instructions to the robotic arm to move the testing probe to a location where the touch pin is above the location on the touch panel where that key is shown and instruct the robotic arm to move the touch pin on the surface of the touch panel and retract the touch pin from the surface of the touch panel. This operation effects that the device under test should react to the touch as if a human being were touching the touch panel. The camera may also be used to capture images of the display after the touch has been performed to find out the actual response of the device to the touch.

In practical devices the touch pin and the camera are coaxially not located but there is an offset between the location of the touch pin and the camera. This offset should be taken into consideration when images captured by the camera are used to determine the actual or desired location of the touch pin. If the testing apparatus does not have correct information of the offset, the operation of the testing device may not be correct.

A calibration procedure may be performed to determine the actual offset. One method for performing the calibration is to use a planar target sheet which has a visible focusing point such as a cross. Then, the target sheet may be positioned above the touch panel so that the focusing point is located in the middle of the touch pin. After that the touch pin is moved away from the focusing point and the camera of the testing probe is moved to the location where the focusing point is. Hence, the movement which was needed to move the camera to the location of the focusing point reveals the offset between the touch pin and the camera. Such a method is complicated, positioning of the target sheet is a manual operation and the target sheet should be secured to prevent it moving after the target sheet has been manually positioned until the camera has been moved to the correct location.

Industrial robots are typically calibrated during their manufacturing phase in such a manner that the position and orientation of the mechanical tool mounting interface at the last link of the robot can be calculated to a reasonable degree of accuracy. The mechanical interface may allow a multitude of different tools to be mounted onto the robot. A key piece of information is the position of the tool center point (TCP), i.e. the tool tip with respect to the robot mounting interface. This data should be fed into a robot controller for precise control of the tool while performing tasks with the robot. For a completely rigid tool, the location of the tool center point is known to an accuracy, which is limited by the tool manufacturing tolerance and the tolerance of the tool mounting interface. However, a robot tool may have adjustable parts or it may be a holder for replaceable tips, which are manually adjusted into place. In this case, the location of the tool center point may not be known very accurately and should be calibrated by some external measurements to facilitate accurate operation. Also, if the tool accidentally crashes against a workpiece during robot operation, the tool center point may shift. In this case to resume operation, some form of the tool center point adjustment or calibration may be needed.

One basic solution based on touching a mechanical reference point may be simple to implement, but is very sensitive to operator error. A good calibration can only be achieved by a skilled robot operator who has a good eye for positioning the tool tip against the mechanical reference. Solutions based on laser light or cameras assume a rotationally symmetric tool such as a drill bit, plasma cutter, glue nozzle or a welding torch. The calibration procedures are automated based on this assumption. Thus, a non-rotationally symmetric tool may cause all of the above methods to fail.

### SUMMARY

One aim of the disclosed embodiments is to provide an improved method and apparatus for calibrating a testing apparatus. The disclosed embodiments are based on the idea that an image of a reference object is captured by at least one reference camera to determine the location of the reference object, a testing camera of the testing probe is moved above the reference object on the basis of image information provided by the testing camera, wherein that location represents a reference point, a touch pin of the testing probe is moved to a location determined by an initial offset and the location of the reference point, and a location of the touch pin is determined by the at least one reference camera, wherein a difference between the reference point and the location of the touch pin defines an offset error.

In some embodiments the stylus is manually placed in a stylus holder resulting in an unknown tool center point location each time a new stylus is used. Ideally, the tool center point location of a stylus should be set inside a round tip of the stylus to keep the touch activation point of the stylus stationary in the case the stylus is tilted. One way would be to first calibrate the tool center point to the tip of the stylus and then shift the tool center point along the stylus Z-axis an amount equal to the radius of the stylus tip. The correct radius could be verified from a high resolution close-up image, which would also account for any wear of the stylus tip.

In some embodiments there is provided a method and apparatus to solve the tool center point calibration problem in a manner which is not limited to rotationally symmetric tools, and to provide detailed information about the tool tip to enable a post-calibration tool center point shift from the tool tip into to the center of a sphere of a round tip stylus.

According to a first aspect there is provided a method for calibrating a testing probe having at least a camera and a touch pin, the method comprising:

capturing a first image of a reference object in a first direction by a first camera;

capturing a second image of the reference object in a second direction by a second camera; and

using the first image and the second image to determine a difference between a location of a reference point of the reference object and a testing probe.

According to a second aspect there is provided a testing apparatus comprising:

a first camera adapted for capturing a first image of a reference object in a first direction;

a second camera adapted for capturing a second image of the reference object in a second direction;

means for using the first image and the second image to determine a difference between a location of a reference point of the reference object and a testing probe.

According to a third aspect there is provided a computer program product for testing including one or more sequences of one or more instructions which, when executed by one or more processors, cause an apparatus or a system to at least perform the following:

capture a first image of a reference object in a first direction by a first camera;

capture a second image of the reference object in a second direction by a second camera; and

use the first image and the second image to determine a difference between a location of a reference point of the reference object and a testing probe.

Some advantageous embodiments are defined in the dependent claims.

Some advantages may be achieved by the present invention. For example, error in the initial offset may be determined automatically. The reference object need not be put accurately to a certain point, because the actual location of the reference object is determined substantially simultaneously by the reference camera or cameras and the camera of the testing probe, wherein the risk that the reference object moves during the determination of the reference point is very low. In accordance with an embodiment, both the reference camera(s) and the camera of the testing probe capture an image of the reference object exactly simultaneously, which further reduces the risk of incorrect determination of the reference point.

### DESCRIPTION OF THE DRAWINGS

In the following the aspects of the disclosed embodiments will be described in more detail with reference to the appended drawings, in which

FIG. 1 depicts as a simplified block diagram a testing apparatus, in accordance with an example embodiment;

FIG. 2a is a conceptual drawing of a testing probe as a side view according to an example embodiment;

FIG. 2b is a conceptual drawing of the testing probe as a bottom view according to an example embodiment;

FIG. 3a illustrates an example of a calibration setup as a top view, in accordance with an embodiment;

FIG. 3b illustrates the example of a calibration setup of FIG. 3a as a side view;

FIG. 3c illustrates another example of a calibration setup as a top view, in accordance with an embodiment;

FIG. 4 illustrates an example of determining an offset error of a testing probe, in accordance with an embodiment;

FIG. 5 shows as a flow diagram a method according to an example embodiment;

FIG. 6 illustrates another example of a calibration setup;

FIG. 7 illustrates a reference tool tip observed in a camera image, in accordance with embodiment;

FIG. 8 illustrates a testing probe tip observed in a camera image, in accordance with embodiment;

FIG. 9 illustrates determination of a Z-offset of a testing probe tip, in accordance with an embodiment;

FIG. 10 illustrates a rotated testing probe tip observed in a camera image, in accordance with an embodiment; and

FIG. 11 illustrates an example of a shifted tool center point.

### DETAILED DESCRIPTION

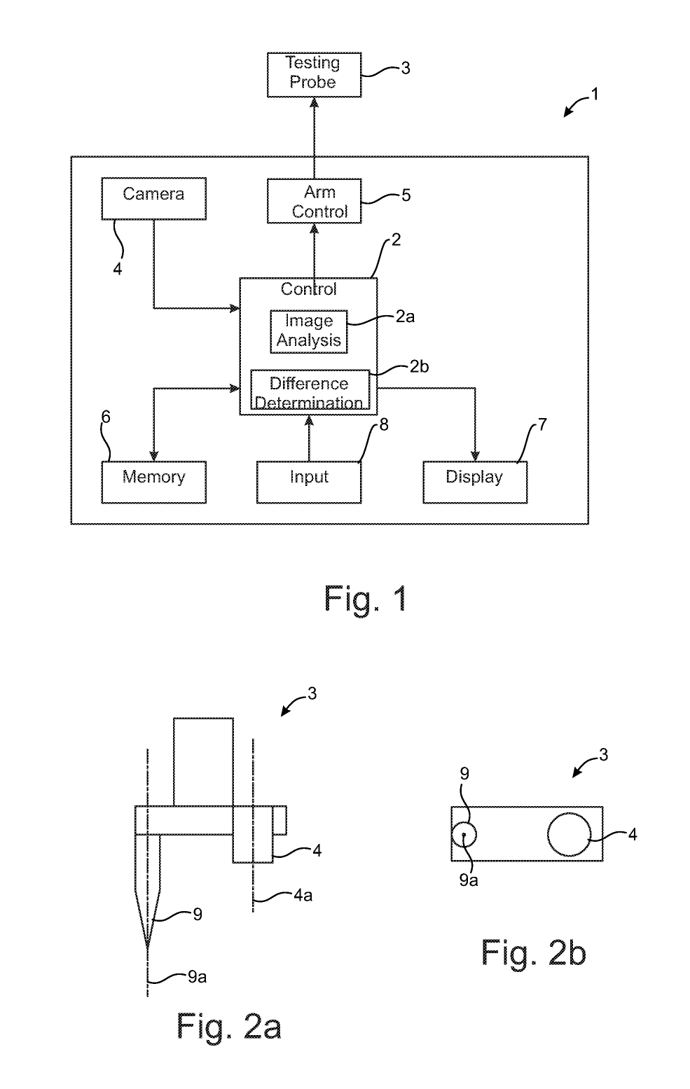

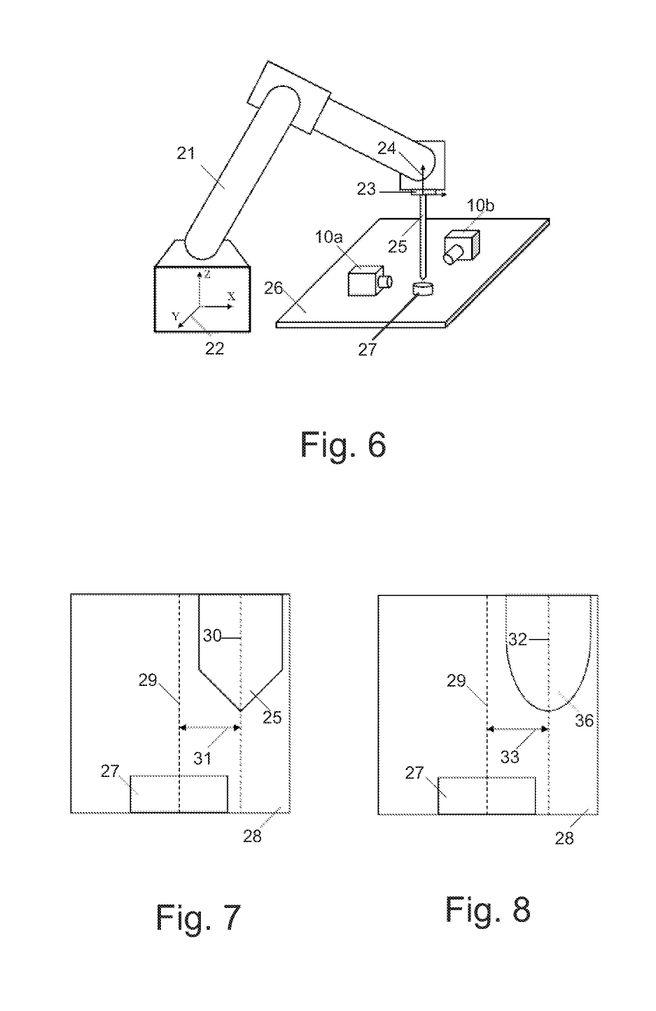

In the following some example embodiments will be described. FIG. 1 is a simplified block diagram of a testing apparatus 1 according to an example embodiment of the present disclosure and FIG. 5 is a flow diagram of a method according to an example embodiment of the present disclosure. The testing apparatus 1 comprises a control block 2, which is adapted to control the operation of the testing apparatus 1. The testing apparatus 1 also comprises a testing probe 3, which comprises a touch pin 9 intended to simulate touches on a device under test (not shown), and a camera 4 intended to capture images during calibrating the testing probe 3 and during testing the device under test. The testing probe 3 may also be called as a stylus, for example. Movements of the testing probe 3 may be achieved by a robotic arm 21 (FIG. 6). The testing apparatus 1 may comprise an arm controller 5 which may provide signals to motors or other corresponding elements of the robotic arm 21 so that the testing probe 3 can be moved as desired. The robotic arm 21 may have two, three or more degrees of freedom. In accordance with an embodiment, the robotic arm 21 has six degrees of freedom, wherein the testing probe 3 is free to move forward/backward, up/down, left/right in three perpendicular axes and also rotate about three perpendicular axes. These movements may be called as pitch, yaw, and roll. Hence, to achieve six degrees of freedom, the arm controller 5 may provide six signals to the motors (not shown) of the robotic arm 21. The testing apparatus 1 may further comprise memory 6 for storing data and/or computer code for operating the testing apparatus 1, a display 7 for displaying information to a user of the testing apparatus 1, and input means 8 such as a keyboard, a pointing device, etc. for receiving instructions from the user.

FIG. 2a is a conceptual drawing of the testing probe 3 as a side view according to an example embodiment and FIG. 2b is a conceptual drawing of the testing probe 3 as a bottom view. The testing probe 3 and the camera 4 of the testing probe 3 are not coaxially aligned, wherein there is an offset 15 between a centerline 9a of the touch pin 9 and a centerline 4a of the camera 4. In other words, the touch pin 9 and the camera 4 do not share the same centerline. The offset may be one-dimensional or two-dimensional. In the following, it is assumed that the offset is two-dimensional having both an x-component (x-offset) and a y-component (y-offset). In some embodiments the offset may even have a third component (z-component, depth or height). It should be noted here that the following principles to calibrate a two-dimensional offset are also applicable to both one-dimensional and three-dimensional offsets.

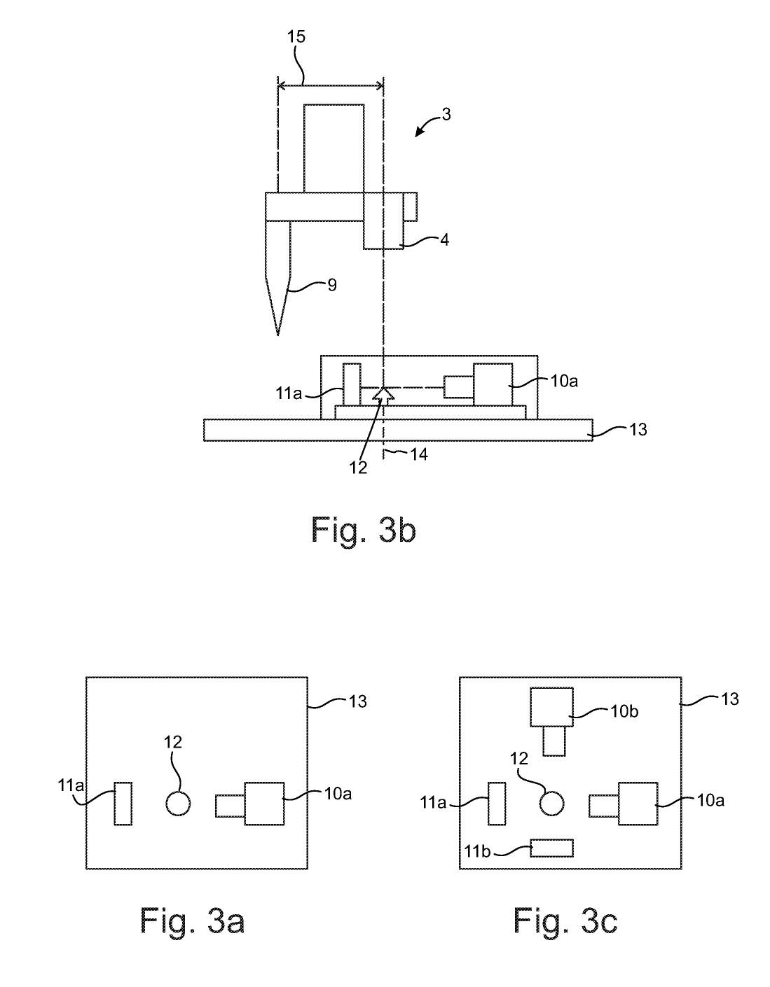

In the following, the calibration of the offset will be described in more detail. An example of a calibration setup is depicted in FIG. 3a as a side view and in FIG. 3b as a top view. The calibration setup comprises one or more calibration cameras 10a, 10b, one or more backlights 11a, 11b, a reference object 12, and a platform 13. In the example of FIGS. 3a and 3b there is a first calibration camera 10a, a second calibration camera 10b, a first backlight 11 a and a second backlight 11b. It can be defined without losing generality that the first calibration camera 10a and the first backlight 11a may be used to determine an error in the X-direction and the second calibration camera 10b and the second backlight 11b may be used to determine an error in the Y-direction.

The reference object 12 may be positioned at a reference point 14, which the user may select within the surface of the platform 13. The reference point 14 should be selected so that it is located somewhere between the first calibration camera 10a and the first backlight 11a and between the second calibration camera 10b and the second backlight 11b, wherein the reference object 12, when laying at the reference point 14, blocks some light of the first backlight 11 a from the view of the first calibration camera 10a and blocks some light of the second backlight 11b from the view of the second calibration camera 10b. When the reference object 12 has been put on the reference point 14, the control block 2 may instruct the calibration cameras 10a, 10b to capture one or more images. The captured images are received by the testing apparatus 1, wherein the control block 2 may examine the images to find out the location of the reference object 12. This may be performed, for example, by using pattern recognition algorithm(s) or other corresponding means. In other words, the control block 2 may use computer code to perform the pattern recognition algorithm. In accordance with an embodiment, the control block 2 tries to find the location of a centerline 12a of the reference object 12. This may be performed e.g. by finding edges of the reference block from an image captured by the first calibration camera 10a and an image captured by the second calibration camera 10b (block 50 in FIG. 5). Alternatively or in addition to, the reference object 12 may have a peak 12b or another detectable form at the location of the centerline 12a.

The control block 2 may comprise an image analyzer 2a for analyzing the images and a difference determinator 2b. The image analyzer 2a and the difference determinator 2b may be implemented e.g. as a computer code, by hardware or both.

Furthermore, the control block 2 instructs the testing probe 3 to move so that the centerline 4a of the camera 4 of the testing probe 3 is located at the reference point 14. This may be achieved by using the pattern recognition algorithm, for example. The camera 4 views the reference object 12 above wherein images captured by the camera 4 sees the top view of the reference object 12 (block 51). The location of the camera 12 may be adjusted so that the pattern recognition algorithm determines the location of the centerline 12b of the reference object. The control block 2 may use the determined location of the centerline 12b of the reference object 12 to adjust the location of the camera 4 until the centerline 4a of the camera is at the determined location of the centerline 12b of the reference object, i.e. the reference point 14 (block 52).

When the camera 4 has been moved to the location where the centerline 4a of the camera corresponds with the reference point 14, the control block 2 may use an initial offset value to instruct the robotic arm to move the testing probe 3 so that the touch pin 9 moves towards the reference point 14. This may be achieved by moving the testing probe 3 from the current location to a location indicated by the offset value. In other words, in the two-dimensional case the current x,y—location would be adjusted by the x-offset value and y-offset value. Therefore, if the initial offset value were correct i.e. were exactly the same as the actual offset value, the touch pin 9 would be at the reference point 14, However, this is not always the case wherein an error in the initial offset value should be determined and corrected. This may be performed e.g. as follows. When the testing probe 3 has been moved to the presumed location, the calibration camera(s) 10a, 10b capture one or more images of the scene where the reference point 14 is located. If the touch pin 9 is in the view of the calibration camera(s) 10a, 10b, the touch pin 9 blocks a part of the backlight 11a, 11b, wherein the image should include a shadow of the touch pin 9. Thus, the image maybe analyzed by an appropriate pattern recognition algorithm to find out the contours of the image (shadow) of the touch pin 9. The contours may be used to determine the centerline 9a of the touch pin in the image. The centerline 9a of the touch pin may then be mapped to coordinates of the platform 13. The coordinates of the centerline 9a of the touch pin may be compared with the coordinates of the reference point 14 to find out the difference between the centerline 9a of the touch pin and the reference point 14. This difference corresponds with the error in the initial offset. Hence, the control block 2 may adjust the initial offset by adding/subtracting the difference to/from the initial offset value.

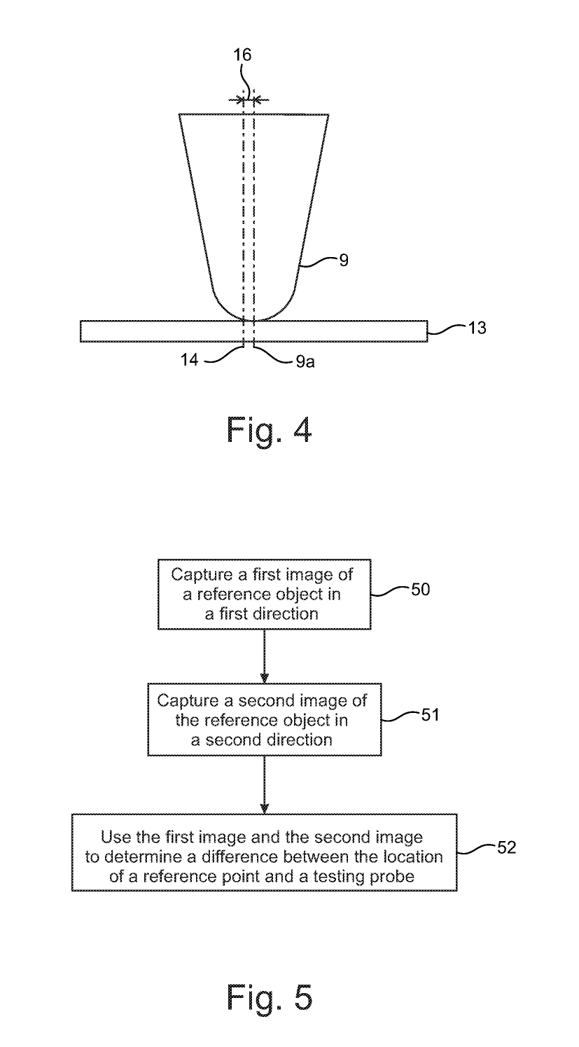

FIG. 4 illustrates the error in the offset in one direction. FIG. 4 shows the location of the reference point 14 and the shadow of the touch pin 9. The centerline 9a of the touch pin is also marked in FIG. 4. The error is depicted with the reference numeral 16.

The moment when the calibration camera(s) 10a, 10b capture the image(s) of the scene may depend on the height of the touch pin 9. In accordance with an embodiment, the capturing is performed when the touch pin 9 actually touches the platform 13, but it may also be performed just before the touch pin 9 approaches the platform 13. The touch of the touch pin 9 may be detected in many ways. For example, the testing probe 3 may comprise means to detect the touch (not shown), or the calibration cameras 10a, 10b and/or the camera 4 of the testing probe may capture images, wherein the image information may be used to determine when the touch pin 9 is touching the platform 13 or is near enough the platform 13 for the calibration purposes. Still another option for the touch detection is to use conductive platform or conductive coating on the surface of the platform 13 and a conductive touch pin 9 or conductive coating on the surface of the touch pin 9. Hence, the platform 13 and the touch pin 9 operate as a switch and it is able to detect whether the switch is open (is not touching) or closed (is touching).

When the error in the offset has been detected and corrected, the testing apparatus may be used to test a device under test.

FIG. 6 illustrates another embodiment of the present disclosure. The system consists of a robotic manipulator illustrated in FIG. 6, the robot having an articulated frame 21 consisting of one or more links and joints and tool mounting flange 23 at the last link. For common commercial industrial manipulators, the robot pose is available from the robot control system, which refers to the position and orientation of the tool flange coordinate system 24 with respect to the robot base coordinate system 22. A reference tool 25 is attached to the flange 23 in such a manner that the orientation of the reference tool 25 matches the orientation of the tool flange coordinate system 24 and the longitudinal axis of the tool is coincident with the tool flange Z-axis. A first camera 10a and a second camera 10b are attached on a rigid mounting surface 26 in orthogonal directions. A mechanical reference object 27 of known dimensions is placed in the view of both cameras 10a, 10b. The camera mounting surface 26 is oriented in such a manner with respect to the robot coordinate system 22 that the optical axis of the first camera 10a is parallel to the robot X-axis and the optical axis of the second camera 10b is parallel to the robot Y-axis.

In the first phase, the XY-position of the mechanical reference object 27 with respect to the robot base coordinate system 22 is determined. This may be achieved by positioning the reference tool 25 with the robot into the view of both cameras 10a and 10b in a vertical orientation. Because Z-axes of the tool flange 23 and the reference tool 25 are coincident, the XY-position reported by the robot controller corresponds to the XY-position of the reference tool centerline in the vertical tool orientation. FIG. 7 illustrates the reference tool as seen in an image 28 of one of the cameras 10a, 10b. The offset 31 between the centerline 29 of the reference object 27 and the centerline 30 of the reference tool 25 in the image 28 of the first camera 10a may be used to calculate the Y-coordinate of the position of the reference object 27 with respect to the robot base coordinate system 22. Because the reference tool 25 is rotation symmetric in this example embodiment, a simple image processing algorithm may be used to quickly find the tool centerline 30 from the captured image 20. Knowledge of the reference object dimensions (e.g. width) is used to equate pixels in the camera image 20 into millimeters. A similar procedure for the image of the second camera 10b may be used to calculate the X-coordinate of the reference object 27 with respect to the robot base coordinate system 22.

Next, the actual tool to be used, e.g. a stylus 36 of unknown dimensions is attached to the tool flange 23 but now unknown offsets may exist between the stylus centerline 32 and the tool flange Z-axis. However, it is assumed that the tool centerline is parallel to the flange Z-axis. The robot is commanded to move to the XY-position of the reference target 27 determined in the previous phase, keeping the tool vertical and selecting a Z height where the tool tip is visible in the camera images as before. FIG. 8 illustrates the stylus 36 as seen in the image 28 of one of the cameras. Now the offset 33 between the centerline 29 of the reference object 27 and the centerline 32 of the stylus 36 in the image 28 of the first camera 10a directly determines the Y-axis offset between the stylus Z-axis and the tool flange 23 Z-axis, since the XY-position of the tool flange is assumed to be coincident with the position of the mechanical reference 27. A similar procedure for the image of the second camera 10b may be used to calculate the X-offset with respect to the tool flange 23. Again, because the stylus 36 is rotation symmetric, a simple image processing algorithm may be used to quickly find the tool centerline 32.

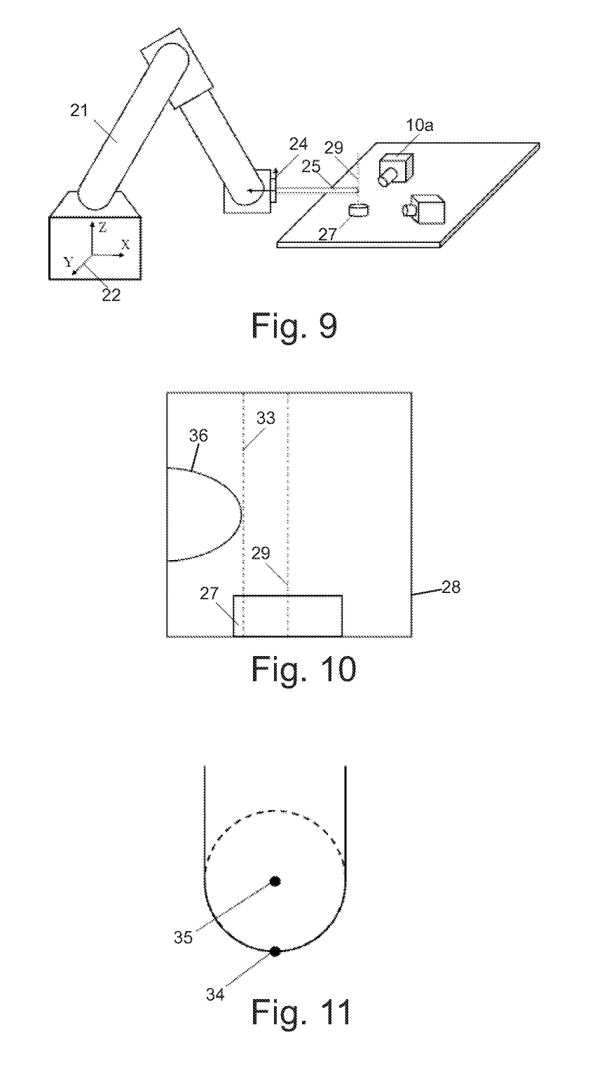

In the final phase, the Z-offset (length) of the stylus 36 may be determined. This may be achieved by e.g. first rotating the tool flange 23 about the X-axis of the robot coordinate system 22 in such a manner, that the tool flange Z-axis is parallel to the robot coordinate system Y-axis (FIG. 9). Then, the robot is commanded to move the stylus tip in this orientation into the view 28 of the first camera 10a. The difference between the furthest point of the stylus 36 and the centerline 29 of the mechanical reference 27 can be used to calculate the Z-offset of the stylus. As before, an image processing algorithm may be used to find the furthest point of the stylus 36 automatically. Now the X, Y and Z-coordinates of the stylus tip with respect to the tool flange 23 are known and can be fed into the robot controller.

If the tool 36 is not rotationally symmetric, the tool centerline 32 is not necessarily found correctly by an image processing algorithm. In this case, when viewing the tool 36 in the camera image of FIG. 8, the user should indicate the correct tool centerline 32 by e.g. dragging the centerline 32 to its correct position. Similarly, the Z-coordinate of the tool center point determined in FIG. 10 can be indicated by the user.

Certain elements of the disclosed embodiments may be solved differently as follows. The Z-coordinate of the tool center point may also be directly determined with the aid of the reference tool 27 as seen in FIG. 7. Because the dimensions of the reference tool 27 are known, the Z-coordinate of the tip of the reference tool 27 is also known and can be used to store a temporary Z-coordinate reference into the camera image 28. The tool center point calibration can then be performed from a single observation of the tool 36 in a vertical orientation.

If the optical axes of the cameras 10a, 10b cannot be accurately made parallel to the robot axes, the orientation of the cameras fixed on the mounting surface 26 should be determined. The orientation may be solved by moving the reference tool 27 to various points in the camera view 28 to create direction vectors, which are known both in the robot base coordinate system 22 and the camera coordinate system. The unknown rotation between the robot base coordinate system 22 and the camera coordinate system may then be solved with linear algebra.

As previously described, for touch display testing applications the ideal tool center point location of a stylus may be inside the round tip of the stylus 36. This may allow keeping the touch activation point of the stylus 36 stationary in the case the stylus 36 is tilted. FIG. 11 illustrates the case, in which the tool center point location 34 is first identified at the tool tip and then shifted to the center of sphere 35 of the stylus tip. The correct position for the shifted tool center point can be identified with the aid of one of the cameras. Even if the exact geometry and dimensions of the stylus tip are not known, a sphere of suitable size can be adjusted by the user and overlaid on top of the stylus tip to find a reasonably good approximation of the center of sphere. Additionally, once the shifted tool center point location 35 is fed into the robot controller, the user can change the orientation of the tool and observe the tool motion in the close-up view of the camera and readjust the shifted tool center point location if needed.

In the following some examples will be provided.

According to a first example there is provided a method for testing comprising:

capturing a first image of a reference object in a first direction by a first camera;

capturing a second image of the reference object in a second direction by a second camera;

using the first image and the second image to determine a difference between a location of a reference point of the reference object and a testing probe.

In accordance with an embodiment the method further comprises:

using a camera attached at a distance with respect to said testing probe as said second camera;

using said second image to adjust the location of the testing probe so that the camera of the testing probe is located at the reference point;

adjusting the location of testing probe on the basis of an offset;

capturing a third image of the touch pin by the first camera;

using the third image to determine a location of the testing probe;

determining a difference between the location of the testing probe and the reference point; and

correcting the offset on the basis of the difference.

In accordance with an embodiment the method further comprises:

capturing the second image from above the reference object to see a top view of the reference object;

adjusting the location of the second camera so that the location of the centerline of the reference object is detected at a center of the view of the second camera.

In accordance with an embodiment the method further comprises:

illuminating the reference object located at a reference point by a first illumination unit towards the first camera.

In accordance with an embodiment the method further comprises:

using the first image to determine a first offset of the testing probe with respect to the location of the reference point in the second direction; and

using the second image to determine a second offset of the testing probe with respect to the location of the reference point in the first direction; and

using the first offset and the second offset to determine a reference location where a tool tip is located when the testing probe is located at the reference point.

In accordance with an embodiment the method further comprises:

replacing the testing probe with another testing probe in a tool mounting flange;

moving the tool mounting flange to the reference location; capturing a third image of the another testing probe in the first direction by the first camera;

capturing a fourth image of the another testing probe in the second direction by the second camera;

using the third image and the fourth image to determine a difference between the actual location of the another testing probe and the reference point.

According to a second example there is provided a testing apparatus comprising:

a first camera adapted for capturing a first image of a reference object in a first direction;

a second camera adapted for capturing a second image of the reference object in a second direction;

means for using the first image and the second image to determine a difference between a location of a reference point of the reference object and a testing probe.

In accordance with an embodiment the apparatus further comprises:

a tool mounting flange adapted to receive the testing probe;

said second camera attached with the tool mounting flange at a distance with respect to said testing probe as;

means for using said second image to adjust the location of the testing probe so that the second camera is located at the reference point;

means for adjusting the location of testing probe on the basis of an offset;

wherein the apparatus is adapted to:

capture a third image of the touch pin by the first camera;

use the third image to determine a location of the testing probe;

determine a difference between the location of the testing probe and the reference point; and

correct the offset on the basis of the difference.

In accordance with an embodiment the apparatus is adapted to:

capture the second image from above the reference object to see a top view of the reference object; and

adjust the location of the second camera so that the location of the centerline of the reference object is detected at a center of the view of the second camera.

In accordance with an embodiment the apparatus is adapted to:

use the first image to determine a first offset of the testing probe with respect to the location of the reference point in the second direction;

use the second image to determine a second offset of the testing probe with respect to the location of the reference point in the first direction; and

use the first offset and the second offset to determine a reference location where a tool tip is located when the testing probe is located at the reference point.

According to a third example there is provided a computer program product for testing including one or more sequences of one or more instructions which, when executed by one or more processors, cause an apparatus or a system to at least perform the following:

capture a first image of a reference object in a first direction by a first camera;

capture a second image of the reference object in a second direction by a second camera; and

use the first image and the second image to determine a difference between a location of a reference point of the reference object and a testing probe.

According to a fourth example there is provided a method for testing comprising:

illuminating a reference object located at a reference point by a first illumination unit;

capturing a first image of the reference object towards the illumination unit by a first camera;

using the first image to determine a location of a reference point of the reference object;

capturing a second image of the reference object by a camera of a testing probe;

using the second image to adjust the location of the testing probe so that the camera of the testing point is located at the reference point;

adjusting the location of testing probe on the basis of an offset;

capturing a third image of the touch pin by the first calibrating camera;

using the third image to determine a location of the touch pin;

determining a difference between the location of the touch pin and the reference point; and

correcting the offset on the basis of the difference.

The present invention is not limited to the above described embodiments but can be modified within the scope of the appended claims.

1. A method for testing comprising:
capturing a first image of a reference object in a first direction by a first camera;
capturing a second image of the reference object in a second direction by a second camera;
using the first image and the second image to determine a difference between a location of a reference point of the reference object and a testing probe.

2. The method according to claim 1 further comprising:
using a camera attached at a distance with respect to said testing probe as said second camera;
using said second image to adjust the location of the testing probe so that the camera of the testing probe is located at the reference point;
adjusting the location of testing probe on the basis of an offset;
capturing a third image of the touch pin by the first camera;
using the third image to determine a location of the testing probe;
determining a difference between the location of the testing probe and the reference point; and
correcting the offset on the basis of the difference.

3. The method according to claim 2 further comprising:
capturing the second image from above the reference object to see a top view of the reference object;
adjusting the location of the second camera so that the location of the centerline of the reference object is detected at a center of the view of the second camera.

4. The method according to claim 1 further comprising:
illuminating the reference object located at a reference point by a first illumination unit towards the first camera.

5. The method according to claim 1 further comprising:
using the first image to determine a first offset of the testing probe with respect to the location of the reference point in the second direction; and
using the second image to determine a second offset of the testing probe with respect to the location of the reference point in the first direction; and
using the first offset and the second offset to determine a reference location where a tool mounting flange is located when the testing probe is located at the reference point.

6. The method according to claim 5 further comprising:
replacing the testing probe with another testing probe in a tool mounting flange;
moving the tool mounting flange to the reference location;
capturing a third image of the another testing probe in the first direction by the first camera;
capturing a fourth image of the another testing probe in the second direction by the second camera;
using the third image and the fourth image to determine a difference between the actual location of the another testing probe and the reference point.

7. A testing apparatus comprising:
a first camera adapted for capturing a first image of a reference object in a first direction;
a second camera adapted for capturing a second image of the reference object in a second direction;
a difference determination adapted for using the first image and the second image to determine a difference between a location of a reference point of the reference object and a testing probe.

8. The apparatus according to claim 7 further comprising:
a tool mounting flange adapted to receive the testing probe;
said second camera attached with the tool mounting flange at a distance with respect to said testing probe;
an image analyzer for using said second image to adjust the location of the testing probe so that the second camera is located at the reference point; and
an arm controller for adjusting the location of testing probe on the basis of an offset;
wherein the apparatus is adapted to:
capture a third image of the touch pin by the first camera;
use the third image to determine a location of the testing probe;
determine a difference between the location of the testing probe and the reference point; and
correct the offset on the basis of the difference.

9. The apparatus according to claim 8, wherein the apparatus is adapted to:
capture the second image from above the reference object to see a top view of the reference object; and
adjust the location of the second camera so that the location of the centerline of the reference object is detected at a center of the view of the second camera.

10. The apparatus according to claim 7, wherein the apparatus is adapted to:
use the first image to determine a first offset of the testing probe with respect to the location of the reference point in the second direction;
use the second image to determine a second offset of the testing probe with respect to the location of the reference point in the first direction; and
use the first offset and the second offset to determine a reference location where a tool mounting flange is located when the testing probe is located at the reference point.

11. A computer program product for testing including one or more sequences of one or more instructions which, when executed by one or more processors, cause an apparatus or a system to at least perform the following:
capture a first image of a reference object in a first direction by a first camera;
capture a second image of the reference object in a second direction by a second camera; and
use the first image and the second image to determine a difference between a location of a reference point of the reference object and a testing probe.
